(19) United States
(12) Patent Application Publication
(10) Pub. No.: US 2024/0020133 A1
(43) Pub. Date: Jan. 18, 2024

(54) SYSTEMS AND METHODS TO BRIDGE PLATFORMS

(71) Applicant: MicroStrategy Incorporated, Tysons Corner, VA (US)

(72) Inventor: Jianglong MA, Ningbo (CN)

(21) Appl. No.: 17/812,039

(22) Filed: Jul. 12, 2022

(51) Int. Cl. G06F 9/445; G06F 9/54

(52) U.S. Cl. CPC G06F 9/44521; G06F 9/541

(57) ABSTRACT

Systems and techniques are disclosed herein for initiating a first library within a first framework, the first framework including first library code, calling a bridge using the first library code, the bridge including bridge code to call second library components from a second library, wherein the bridge code to call the second library components is incompatible with the first library, initiating runtime integration of the first library within the first framework, the runtime integration including compiling the first library code and the bridge code to call the second library components of the second library; and rendering first library components and the second library components within the first framework.

### TECHNICAL FIELD

Various embodiments of the present disclosure relate generally to methods and systems to bridge platforms and, more specifically, to a bridge that enables rendering components using a first library within a second library's framework.

### BACKGROUND

Legacy code libraries are often incompatible with newer code libraries such that components available via newer code libraries are often unable to be rendered using legacy code libraries. This incompatibility results in requiring costly updates to legacy code libraries and corresponding frameworks. The incompatibility further limits the capability of frameworks built around legacy code libraries.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems, methods, are disclosed for bridging platforms. According to an aspect, a method may include initiating a first library within a first framework, the first framework comprising first library code; calling a bridge using the first library code, the bridge comprising bridge code to call second library components from a second library, wherein the bridge code to call the second library components is incompatible with the first library; initiating runtime integration of the first library within the first framework, the runtime integration comprising compiling the first library code and the bridge code to call the second library components of the second library; and rendering first library components and the second library components within the first framework.

According to another aspect, a system may include at least one memory storing instructions; and at least one processor executing the instructions to perform operations, the operations comprising: initiating a first library within a first framework, the first framework comprising first library code; calling a bridge using the first library code, the bridge comprising bridge code to call second library components from a second library, wherein the bridge code to call the second library components is incompatible with the first library; initiating runtime integration of the first library within the first framework, the runtime integration comprising compiling the first library code and the bridge code to call the second library components of the second library; and rendering first library components and the second library components within the first framework.

According to another aspect, a method may include initiating a Mojo library within a Mojo framework, the Mojo framework comprising Mojo library code; calling a bridge using the Mojo library code, the bridge comprising bridge code to call React library components from a React library, wherein the bridge code to call the React library components is incompatible with the Mojo library; initiating runtime integration of the Mojo library within the Mojo framework, the runtime integration comprising compiling the Mojo library code and the bridge code to call the React library components of the React library; and rendering Mojo library components and the React library components within the Mojo framework.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment of a system using a bridge, according to one or more embodiments.

FIG. 2A depicts a table comparing an example legacy library to an example non-legacy library, according to one or more embodiments.

FIG. 2B depicts legacy library code, according to one or more embodiments.

FIG. 2C depicts non-legacy library code, according to one or more embodiments.

FIG. 3A depicts a flow diagram for a bridge, according to one or more embodiments.

FIG. 3B depicts an example code for implementing a bridge, according to one or more embodiments.

FIG. 3C depicts a flow diagram for implementing a bridge with multiple legacy code libraries, according to one or more embodiments.

FIG. 4 depicts flow chart for rendering non-legacy library components in a legacy framework, according to one or more embodiments.

FIG. 5 depicts flow chart for rendering React library components in a Mojo framework, according to one or more embodiments.

FIG. 6 depicts example code for implementing a host adaptor, according to one or more embodiments.

FIG. 7A depicts example code for calling a bridge using a host adapter, according to one or more embodiments.

FIG. 7B depicts example code for rendering code using a host adapter, according to one or more embodiments.

FIG. 8 depicts an example system that may execute techniques presented herein.

### DETAILED DESCRIPTION OF EMBODIMENTS

Various embodiments of the present disclosure relate generally to methods and systems for integrating non-legacy library components in a legacy library framework using a bridge.

In general, the present disclosure is directed to improving technology used to render components in a framework. Techniques disclosed herein allow integration of non-legacy library components within a legacy library framework. A bridge disclosed herein may be used to integrate non-legacy library components within the legacy library framework. The bridge may be a programing language function which encapsulates all related logic for a legacy framework to render non-legacy library components. Accordingly, the bridge may be used to render components from an incompatible library (e.g., a non-legacy library) by calling the bridge functions. The bridge may be created via an Application Programming Interface (API). The bridge may be used to update a legacy framework such that the legacy framework can be implemented using non-legacy library components. Accordingly, the functionality of a given legacy framework may be improved, increased, made faster, and/or modified to improve storage requirements.

As applied herein, a CPU may include one or more processors and/or may drive components of an electronic system to perform commands (e.g., based on bridge components, user input, code, etc.). One or more CPUs may be connected to motherboards. A CPU may switch back and forth between various tasks to augment multitasking. This may increase the effective processor speed of the CPU. A given CPU may operate in accordance with an operating system (e.g., an operating system running on a VM). A multi-core CPU may include more than one component. A bus interface component may transfer data to and from the CPU and/or one or more components. A server CPU may provide enterprise level scalability and performance.

As disclosed herein, a memory may include a device or system that is used to store information for immediate use in a computer or related computer hardware and digital electronic devices. Memory may operate at a high speed compared to storage, as applied herein. Storage may provide slower access to data in comparison to memory. Contents of memory can be transferred to storage (e.g., via virtual memory). Memory may be implemented as semiconductor memory, where data is stored within memory cells built from MOS transistors on an integrated circuit. Semiconductor memory may include volatile and/or non-volatile memory. Examples of non-volatile memory include flash memory and read-only memory (ROM), programmable read-only memory (PROM), erasable programmable read-only memory (EPROM), electrically erasable programmable read-only memory (EEPROM) memory, and the like. Examples of volatile memory include primary memory such as dynamic random-access memory (DRAM) and fast CPU cache memory such as static random-access memory (SRAM).

As disclosed herein, a legacy library may be a code library that can be used to compile using a coding language (e.g., JavaScript, C++, HTML, CSS, Python, Java, Swift, C #, R., etc.). The legacy library may include a set of routines for a particular operating system or coding language. Depending on the environment or framework, a legacy library may be or include source code, in an intermediate language, or in executable form. A legacy library may correspond to a traditional library that has since been replaced or modified by one or more non-legacy libraries.

As disclosed herein, a non-legacy may be a code library that can be used to compile using a coding language e.g., JavaScript, C++, HTML, CSS, Python, Java, Swift, C #, R., etc.). The non-legacy library may include a set of routines for a particular operating system or coding language. Depending on the environment or framework, a non-legacy library may be or include source code, in an intermediate language, or in executable form. A non-legacy library may be an updated or newer library in comparison to a legacy library and may include or provide components that provide additional or improved functionality in comparison to a legacy library. As disclosed herein, a legacy library may be any first library and a non-legacy library may be any second library.

As disclosed herein, a framework may be a programming tool that provides ready-made components or solutions that are customized in order to speed up development. A framework may include a library or may be implemented using a library (e.g., a legacy or non-legacy library). A framework may provide support for a programing structure. The framework may be implemented by calling available and/or custom pieces of code (e.g., associated with one or more libraries). A framework may include support programs, compilers, code libraries, toolsets, and APIs to develop software and/or render systems. A user may be able to interact with a framework that is based on one or more libraries.

As disclosed herein, a call may refer to one or more function calls or remote procedure calls. A call may causes code for a given function to be executed by a processor. A call may follow a call convention that may be specific to a language, platform, or framework. The call convention may provide low-level details for how code parameters are passed to a function (e.g., to register, stack or heap), how the function passes the result back to the calling component (e.g., a framework), and/or technical details such as how a frame pointer is adjusted. A call may trigger a function on a local or remote component (e.g., a computer or processor).

This disclosure includes discussion of a plurality of legacy and non-legacy libraries. It will be understood that although a given legacy (e.g., Mojo) or non-legacy (React) may generally be discussed herein, the embodiments of the disclosed subject matter apply to any applicable library. Such libraries include, but are not limited to, Mojo libraries, React libraries, JQuery libraries, Backbone libraries, C libraries, diagnostics libraries, general utilities libraries, templates, logback libraries, log libraries, or the like. A legacy library may be a legacy library relative to a non-legacy library. For example, a React library may be a non-legacy library relative to a Mojo library. The relativity between libraries may be based on the functionality, components, and/or attributes associated with respective libraries.

According to embodiments of the disclosed subject matter, a legacy library may be called using a legacy framework. The legacy framework may be any applicable framework that utilizes the legacy library to generate, render, and/or provide one or more components. The legacy framework may additionally utilize one or more other libraries (e.g., legacy or non-legacy libraries) to generate, render and/or provide the one or more components.

The legacy library may be called based on an initiation of an operating system, a program, a platform, or the like. The initiation may be based on activating a device. Activating the device may include turning on the device from an off state or waking the device from a sleep state. The legacy library may be incompatible with a non-legacy library. For example, legacy code based on the legacy library may not be configured to render components of the non-legacy library.

According to embodiments of the disclosed subject matter, a bridge may be accessible by the legacy library. For example, legacy library code may include a pointer to the bridge such that the bridge may be called via the legacy library code in the legacy framework. The legacy library code may be used to call the bridge by identifying one or more of a bridge name, bridge location, bridge pointer, or the like. The legacy library code may call the bridge based predetermined code or based on a user request or input to retrieve one or more non-legacy components.

The bridge may be a function that include bridge code that is non-legacy library code. The bridge code may be used to render non-legacy components. The bridge may further call a bridge API, according to an implementation. The bridge code may correspond to non-legacy library code that calls one or more components from the non-legacy library. In addition to the bridge code, the bridge API may be used to to pull the one or more components from the non-legacy library that are provided in the bridge code. According to an embodiment, a portion of a bridge code may be triggered by a legacy library code such that the portion may indicate which non-legacy components to pull via the bridge and corresponding bridge code. According to another embodiment, a legacy library code may call a bridge such that the full bridge code within the bridge is used to pull one or more components. According to this embodiment, the legacy library code may call one or more bridges from a plurality of bridges, where each bridge may be configured to pull different non-legacy components. For simplicity, this disclosure discusses a “bridge” though it will be understood that a bridge may correspond to one or more other bridges. Accordingly, the bridge and bridge API may allow the non-legacy components to be called via the legacy library code.

According to an embodiment of the disclosed subject matter, a host adapter may be configured to leverage bridge APIs to render and/or destroy non-legacy components automatically at an applicable time by connecting into lifecycles of legacy code. Accordingly, a host adapter may automatically communicate with a bridge API to render and/or destroy non-legacy components based on applicable legacy code (e.g., without accessing a bridge via the legacy code each time a component is to be rendered and/or destroyed). A destroyed component may be one that is no longer rendered or activated within a legacy framework.

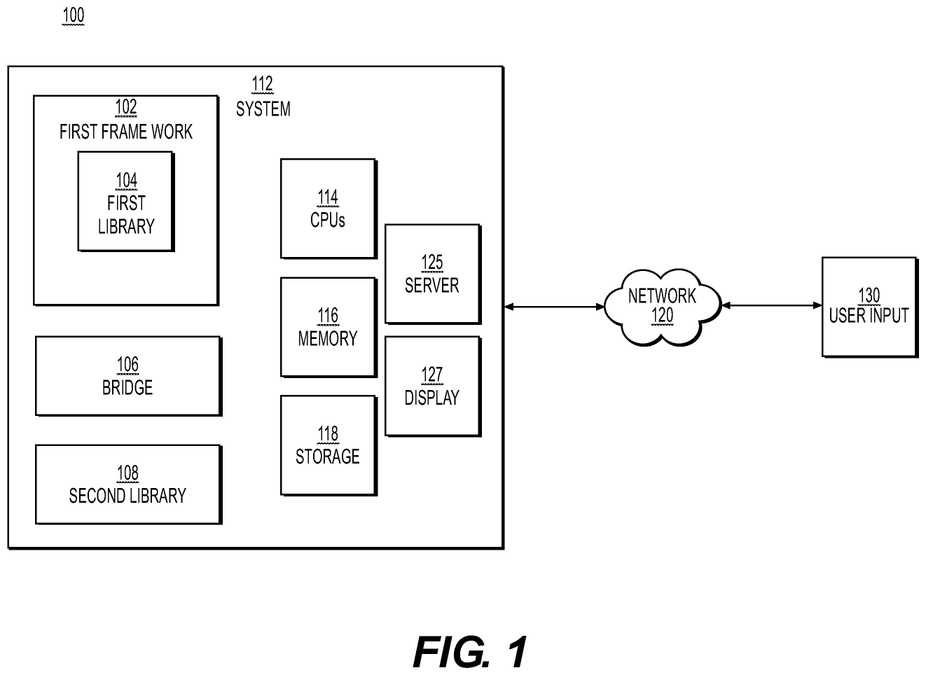

FIG. 1 depicts an exemplary environment 100 in which systems, methods, and other aspects of the present disclosure may be implemented. Environment 100 may include a system 112 that includes a first framework 102, first library 104, bridge 106, second library 108, one or more CPUs 114, memory 116, storage 118, server 125, and display 127. Environment 100 may include a network 120 and user input 130. One or more components of environment 100 may communicate with network 120 in a wired or wireless manner. According to an implementation, server 125 may be a cloud-based server. Each of the depicted resources (e.g., CPUs 114, memory 116, and storage 118) may be located in the same resources location or may be located in different resource locations. Additionally or alternatively, a subset of each of the resources (e.g., a portion of the overall CPUs) may be located in a first location and a different subset may be located in a second different location.

First framework 102 may be a legacy framework rendered using, for example, first library 104 components and/or code. First library 104 code may point to bridge 106, as disclosed herein. Bridge 106 may include second library 108 code such that triggering bridge 106 may result in pulling second library 108 components, as disclosed herein. First framework 102, first library 104, bridge 106, and/or second library 108 may be accessed and/or stored in memory 116 and/or storage 118 via CPUs 114 over server 125. First library 104 and/or second library 108 components may be rendered via display 127. User input 130 may be received over network 120 and may be used to trigger first library 104 code or components and/or second library 108 code or components (e.g., via bridge 106, a host adapter, etc.).

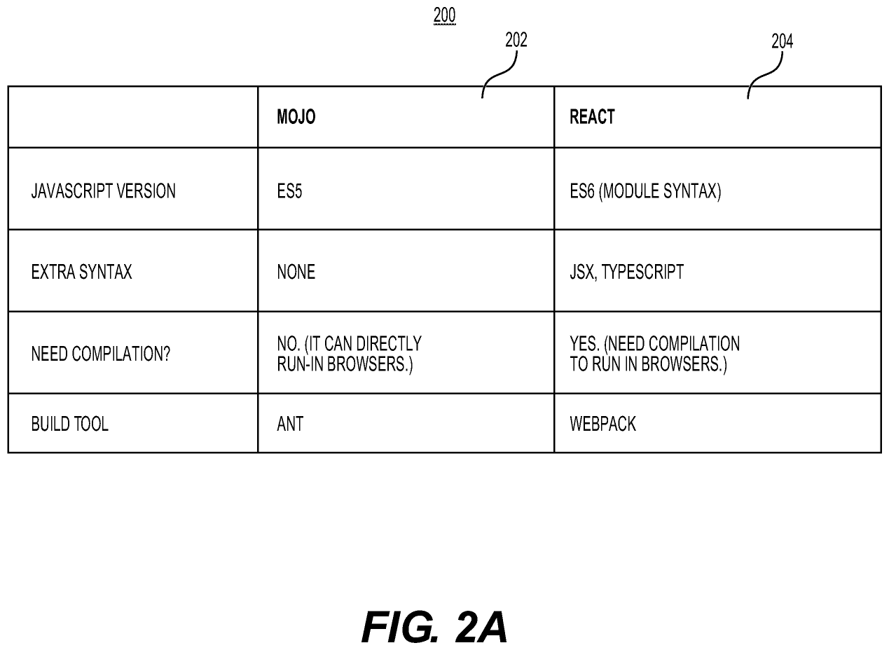

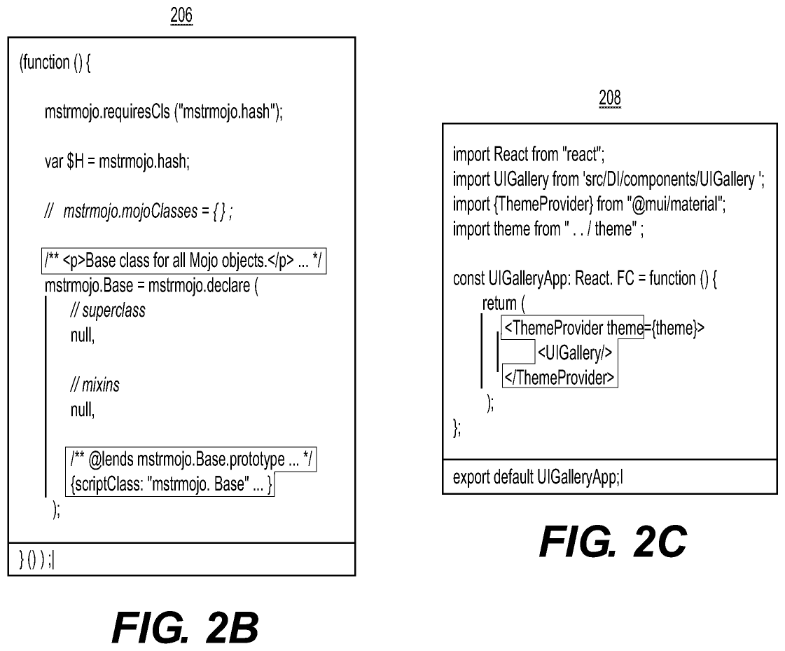

FIG. 2A depicts a table 200 comparing an example legacy library 202 to an example non-legacy library 204. In this example, legacy library 202 is a Mojo library and non-legacy library 204 is a React library. It will be understood that non-legacy library 204 is a non-legacy library relative to legacy library 202 such that in another implementation, a React library may be a legacy library relative to another improved non-legacy library. As shown in FIG. 2A, legacy library 202 may correspond to a JavaScript version ES5 compared to an updated JavaScript version ES6 for non-legacy library 204. Legacy library 202 may not be compatible with extra syntax whereas non-legacy library 204 may be compatible with JSX, and TypeScript, as shown in table 200. Legacy library 202 may not need compilation whereas non-legacy library 204 may need compilation to run in a browser. The build tool for legacy library 202 may be Ant whereas the build too for non-legacy library 204 may be Webpack. Accordingly, legacy library 202 may not be directly compatible with non-legacy library 204.

FIG. 2B depicts legacy library code 206 and FIG. 2C depicts non-legacy library code 208. As shown, the legacy library code 206 may be different than non-legacy library code 208. For example, legacy library code 206 may call a legacy library (e.g., a mojo library) whereas non-legacy library code 208 may call a non-legacy library (e.g., a React library), among other differences.

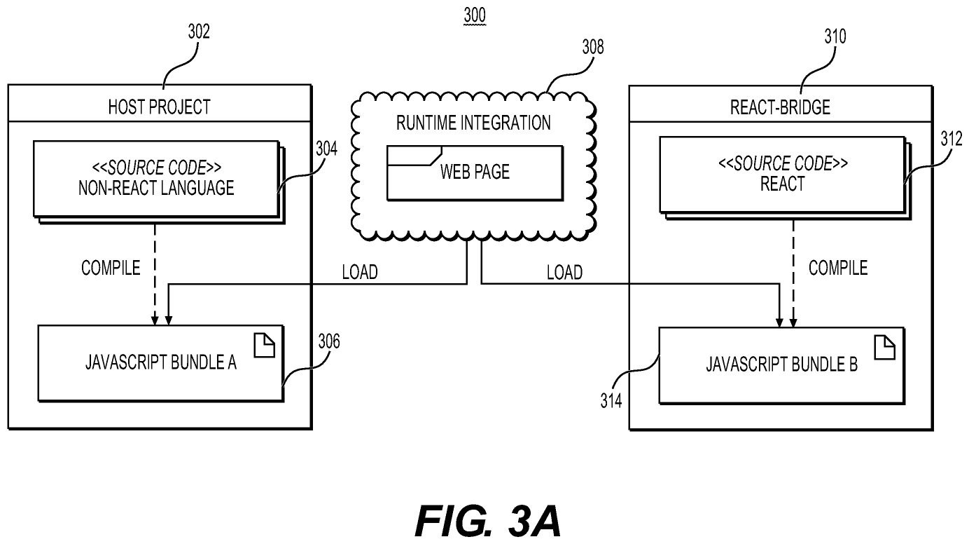

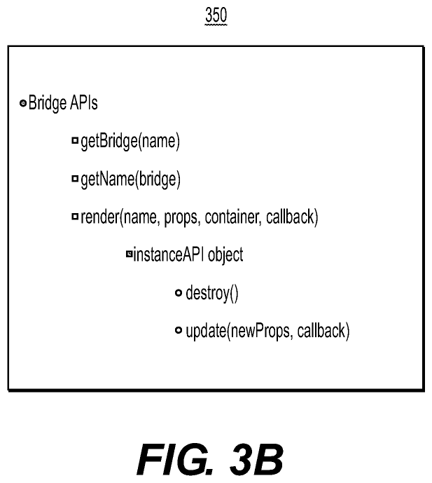

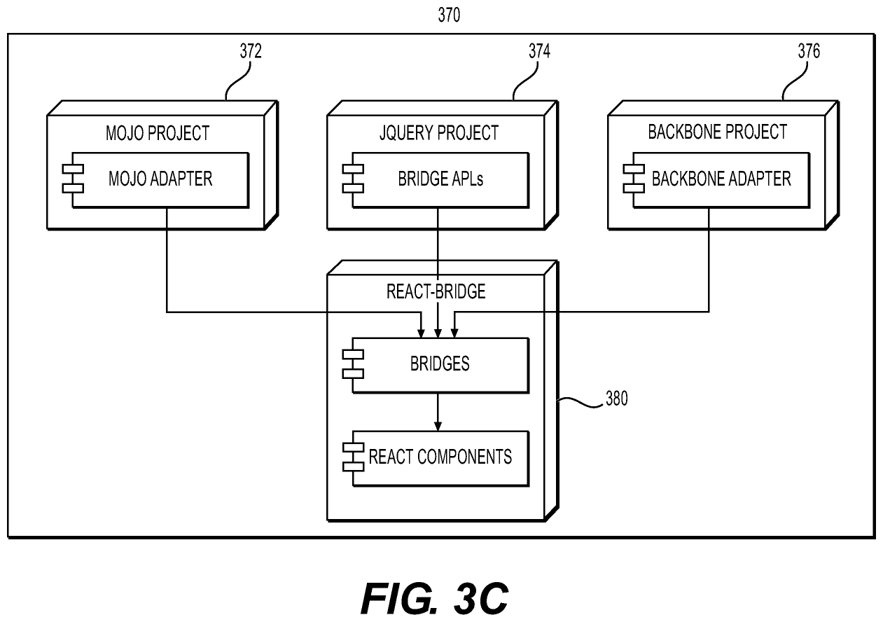

FIG. 3A depicts a flow diagram 300 for a bridge, in accordance with the subject matter disclosed herein. In the example shown in FIG. 3A, the non-legacy library may correspond to a React library and, accordingly, bridge 310 may be a React bridge. A host project 302 may include legacy source code 304 (e.g., Mojo code or another non-react language). The legacy source code 304 may render legacy components upon runtime integration 308. Additionally, non-legacy source code 304 may call bridge 310 that incudes non-legacy source code 312 to trigger an API to call non-legacy components. JavaScript Bundle A 306 may be compiled based on legacy source code 304 and JavaScript Bundle B 314 may be compiled based on bridge non-legacy source code 312. JavaScript Bundle A 306 and JavaScript Bundle B 314 may both be used to render a webpage upon runtime integration 308, such that the webpage includes both legacy components and non-legacy components.

FIG. 3B depicts an example bridge code 350 for implementing a bridge using a bridge API. The bridge code may include activating a bridge based on a bridge name, and may define one or more components to render. The one more components to render may be rendered based on a component name, prop, container, and/or callback. An API object may be used to trigger the components, destroy the components and/or update components via updated props and/or callbacks.

FIG. 3C depicts a flow diagram 370 for implementing a bridge with multiple legacy code libraries. A Mojo Project library 372, JQuery Project library 374, and/or backbone project library 376 may be used with applicable adapters and/or APIs to trigger a non-legacy bridge 380 (e.g., a React bridge) to render React components, as disclosed herein. Accordingly, it will be understood that a bridge, as disclosed herein, may allow rendering and use of non-legacy components for one or more legacy libraries.

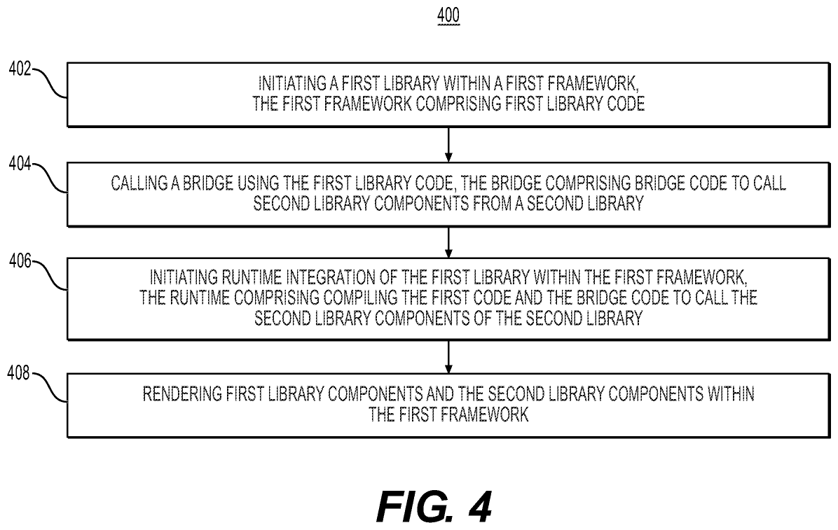

FIG. 4 depicts flow chart 400 for rendering non-legacy library components in a legacy framework. At 402, a first library may be initiated within a first framework. The first framework may include first library code such that it may be initiated based on the first library code. The first library may be a legacy library and the first framework may be legacy framework. As an example, the first library may be a Mojo library and the first framework may be a Mojo framework.

The first library code may include a pointer location to a bridge. A bridge may include or have access to non-legacy components and may include a plurality of bridges, as disclosed herein. The bridge may include or call a bridge API to access the non-legacy components. A bridge API may be globally exposed for legacy code to invoke a bridge and/or manage non-legacy components. The bridge may be a sub-project within a legacy framework. At 404, the bridge may be called using the first library code. The bridge may include bridge code to call second library components from a second library, as disclosed herein. The first library code may be used to call the bridge using the pointer location to the bridge. The second library may be a React library or any other non-legacy library.

At 406, runtime integration of the first library within the first framework may be initiated. During runtime integration, the first code and the bridge code may be compiled to call first library components and second library components. Initiating runtime integration may include compiling the first code and the bridge code using JavaScript. Initiating runtime integration may further include triggering a bridge API such that the bridge code calls the second library components using the bridge API.

At 408, first library components and second library components may be rendered within the first framework. Rendering the first library components and the second library components may be based on rendering the first code using a coding language (e.g., JavaScript) and rendering the second code using the same coding language. Accordingly, legacy components (e.g., first library components) and non-legacy components (e.g., second library components) may both be rendered within the first framework (e.g., a legacy framework). A non-legacy component called using a bridge may be called a first time, and may be used within a non-legacy framework thereafter (e.g., without accessing the bridge).

According to embodiments of the disclosed subject matter, user inputs may be received. The user inputs may be based on user interaction with second library components. For example, a user may provide one or more user inputs using a user device (e.g., a keyboard, mouse, touch screen, joystick, haptic control, etc.). The user inputs may be processed (e.g., by a processor) using the bridge code and/or the second library (e.g., via the bridge code). A user input result may be rendered based on processing the user inputs. The user input results may be generated using the bridge code and/or the second library (e.g., via the bridge code).

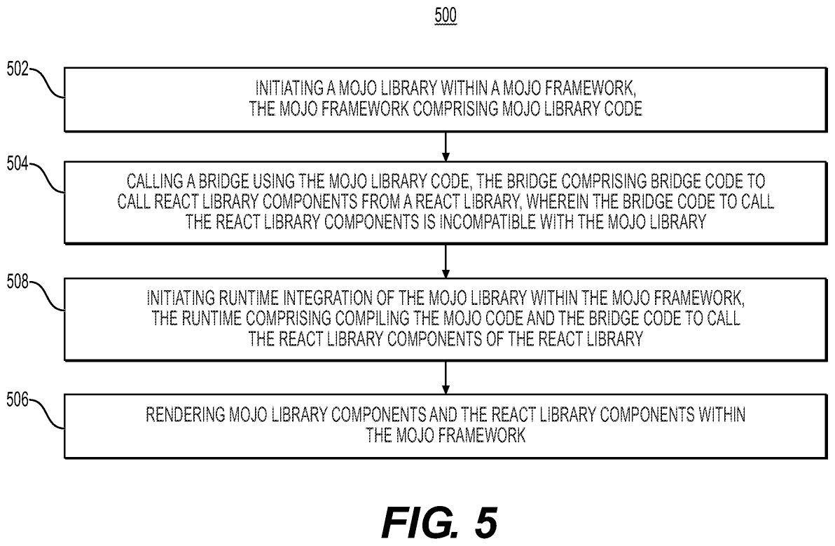

FIG. 5 depicts flow chart 500 for rendering React library components in a Mojo framework. As shown in FIG. 2A, a Mojo library 202 may be a legacy library relative to a non-legacy React library 204. At 502, a Mojo library may be initiated within a Mojo framework. The Mojo framework may include Mojo library code such that it may be initiated based on the Mojo library code.

The Mojo library code may include a pointer location to a bridge. At 504, the bridge may be called using the Mojo library code. The bridge may include bridge code to call React library components from a React library, as disclosed herein. The Mojo library code may be used to call the bridge using the pointer location to the bridge.

At 506, runtime integration of the Mojo library within the Mojo framework may be initiated. During runtime integration, the Mojo code and the bridge code may be compiled to call Mojo library components and React library components. Initiating runtime integration may include compiling the Mojo code and the bridge code using JavaScript. Initiating runtime integration may further include triggering a bridge API such that the bridge code calls React library components using the bridge API.

At 508, Mojo library components React second library components may be rendered within the Mojo framework. Rendering the Mojo library components and the React library components may be based on rendering the Mojo code using a coding language (e.g., JavaScript) and rendering the React code using the same coding language. Accordingly, legacy components (e.g., first library components) and non-legacy components (e.g., second library components) may both be rendered within the first framework (e.g., a legacy framework).

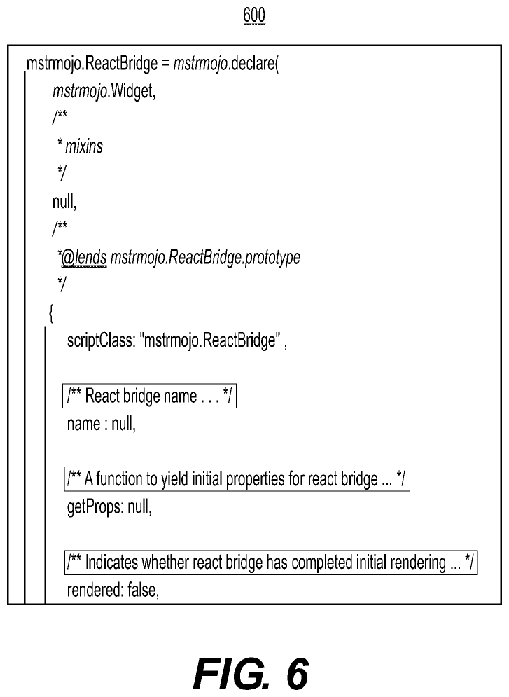

FIG. 6 depicts example code 600 for implementing a host adaptor. A host adapter may be configured to render and/or destroy non-legacy components, within a host framework (e.g., legacy framework), automatically at an applicable time by connecting into lifecycles of legacy code. The host code may render and/or destroy non-legacy components based on such components being made available as global exposed variables via a bridge. A host adapter may allow inserting non-legacy components using an imperative API (e.g., a bridge API) and may render non-legacy components asynchronously. Accordingly, the host adapter may be declarative compared to an imperative component (e.g., in a legacy language). In this manner, a first programming language that renders a UI synchronously may be utilized with a second language for UI rendering and other tasks, even though the second language may render the UI asynchronously. For example, a legacy language (e.g., Mojo) may render components synchronously. The host adapter may provide a placeholder (e.g., a ‘div’ html element). It may then call a bridge API to render non-legacy (e.g., React) components into the placeholder. When the legacy language compiles the corresponding rendering, it may do so with the empty placeholder. Non-legacy components may be rendered asynchronously such that after a duration of time (e.g., approximately 10-900 milliseconds) after rendering legacy components, non-legacy components may finish rendering and the host adapter may notify the caller that the rendering is complete.

The host adapter may be a declarative legacy widget that provides a container for one or more non-legacy components. Legacy components may be imperative but may provide a declarative way (e.g., simpler code syntax) to render UI components (e.g., without a gap). In this manner, imperative code may be kept behind an API, thus concealing imperative logic from the programmer and increasing the intuitive nature of the source code. A host adapter may automatically communicate with a bridge API and/or a Bridge to render and/or destroy non-legacy components based on applicable legacy events (e.g., without accessing a bridge via the legacy code each time a component is to be rendered and/or destroyed). A destroyed component may be one that is no longer rendered or activated within a legacy framework. Example code 600 includes calls to specific bridge code directly using the host adapter, without calling the entire bridge code.

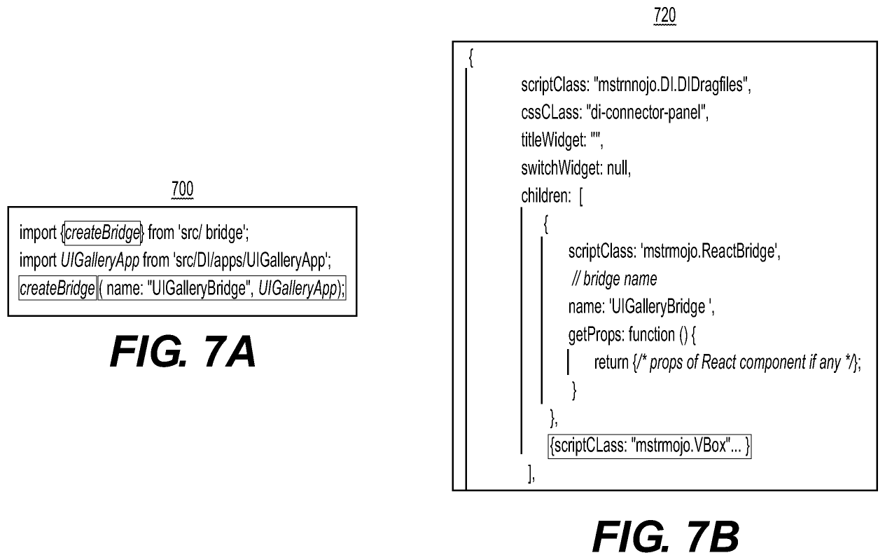

FIG. 7A depicts example code 700 for calling a bridge using a host adapter and FIG. 7B depicts example code 720 for rendering code using the host adapter. As shown in example code 700, a bridge may be triggered to render a UI Gallery. As shown in example code 700, specific functions of the bridge may be called using the host adapter.

In general, any process or operation discussed in this disclosure that is understood to be computer-implementable, such as the flows and/or process illustrated in FIGS. 3A-5, etc., may be performed by one or more processors of a computer system, such any of the systems or devices in the environment of FIG. 1 as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

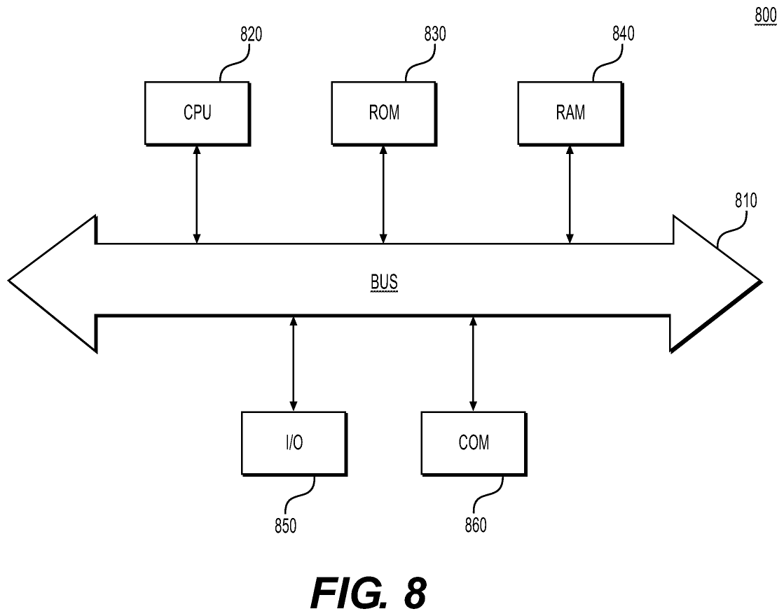

FIG. 8 depicts an example system 800 that may execute techniques presented herein. FIG. 8 is a simplified functional block diagram of a computer that may be configured to execute techniques described herein, according to exemplary embodiments of the present disclosure. Specifically, the computer (or “platform” as it may not be a single physical computer infrastructure) may include a data communication interface 860 for packet data communication. The platform may also include a central processing unit (“CPU”) 820, in the form of one or more processors, for executing program instructions. The platform may include an internal communication bus 810, and the platform may also include a program storage and/or a data storage for various data files to be processed and/or communicated by the platform such as ROM 830 and RAM 840, although the system 800 may receive programming and data via network communications. The system 800 also may include input and output ports 850 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
initiating a first library within a first framework, the first framework comprising first library code;
calling a bridge using the first library code, the bridge comprising bridge code to call second library components from a second library, wherein the bridge code to call the second library components is incompatible with the first library;
initiating runtime integration of the first library within the first framework, the runtime integration comprising compiling the first library code and the bridge code to call the second library components of the second library; and
rendering first library components and the second library components within the first framework.

2. The method of claim 1, wherein the first library is a Mojo library.

3. The method of claim 2, wherein the first framework is a Mojo framework.

4. The method of claim 1, wherein the second library is a React library.

5. The method of claim 1, wherein the first library code comprises a pointer location to the bridge and wherein calling the bridge using the first library code comprises accessing the pointer location to the bridge.

6. The method of claim 1, wherein initiating runtime integration comprises compiling the first library code and the bridge code using JavaScript.

7. The method of claim 6, wherein rendering the first library components and the second library components is based on rendering the first library code using JavaScript and rendering a second library code using JavaScript.

8. The method of claim 1, further comprising receiving user inputs to the rendered second library components.

9. The method of claim 8, further comprising processing the user inputs using one of the bridge code or the second library.

10. The method of claim 9, further comprising rendering a user input result based on processing the user inputs using one of the bridge code or the second library.

11. The method of claim 1, wherein the bridge further comprises a bridge Application Programming Interface (API).

12. The method of claim 11, wherein the bridge code calls the second library components using the bridge API.

13. The method of claim 1, wherein the first framework comprises a host adapter.

14. The method of claim 13, wherein the host adapter is configured to communicate with a bridge API to automatically render and destroy second library components based on first framework events.

15. A system comprising:
at least one memory storing instructions; and
at least one processor executing the instructions to perform operations, the operations comprising:
initiating a first library within a first framework, the first framework comprising first library code;
calling a bridge using the first library code, the bridge comprising bridge code to call second library components from a second library, wherein the bridge code to call the second library components is incompatible with the first library;
initiating runtime integration of the first library within the first framework, the runtime integration comprising compiling the first library code and the bridge code to call the second library components of the second library; and
rendering first library components and the second library components within the first framework.

16. The system of claim 15, wherein the first library code comprises a pointer location to the bridge and wherein calling the bridge using the first library code comprises accessing the pointer location to the bridge.

17. The system of claim 15, wherein initiating runtime integration comprises compiling the first library code and the bridge code using JavaScript.

18. A method comprising:
initiating a Mojo library within a Mojo framework, the Mojo framework comprising Mojo library code;
calling a bridge using the Mojo library code, the bridge comprising bridge code to call React library components from a React library, wherein the bridge code to call the React library components is incompatible with the Mojo library;
initiating runtime integration of the Mojo library within the Mojo framework, the runtime integration comprising compiling the Mojo library code and the bridge code to call the React library components of the React library; and
rendering Mojo library components and the React library components within the Mojo framework.

19. The method of claim 18, wherein the Mojo library code comprises a pointer location to the bridge and wherein calling the bridge using the Mojo library code comprises accessing the pointer location to the bridge.

20. The method of claim 18, wherein the Mojo framework comprises a host adapter, and wherein the host adapter is configured to communicate with a bridge API to automatically render and destroy React library components based on Mojo framework events.
